(19) United States
(12) Patent Application Publication
(10) Pub. No.: US 2016/0368785 A1
(43) Pub. Date: Dec. 22, 2016

(54) METHODS AND SYSTEMS TO REDUCE AIR POLLUTION COMBINED WITH WATER DESALINATION OF POWER STATION'S MARINE WASTE WATER

(71) Applicant: Ilan ZAMIR, Telz-stone (IL)

(72) Inventor: Ilan ZAMIR, Telz-stone (IL)

(21) Appl. No.: 14/740,455

(22) Filed: Jun. 16, 2015

(51) Int. Cl. C02F 1/16; C02F 1/04; B01D 53/18; C02F 1/44; B01D 1/14; B01D 5/00; C02F 1/28; C02F 1/10; B01D 1/00

(52) U.S. Cl. CPC C02F 1/16; C02F 1/10; C02F 1/048; B01D 53/18; B01D 1/0058; B01D 1/14; B01D 5/006; B01D 5/0072; B01D 5/009; C02F 1/283; C02F 1/441; C02F 2101/10

(57) ABSTRACT

A method and a system of conducting a water desalination process by providing an effective combined utilization of waste coolant sea water heat together with combustion waste gases heat that are both generated as waste heat sources at an electrical power station, thus creating a combined-cycle power generation plant and desalination unit for efficient desalination of sea/brackish water. The invention desalination process is also characterized by the use of the waste heat in the exhaust gases from combustion of fossil fuels at the power station while substantially and inherently through the invention desalination process filtering out most contaminating materials within the combustion exhaust gases, thus substantially reducing the atmospheric air pollution created by the power station combustion exhaust gases.

### FIELD AND BACKGROUND OF THE INVENTION

Field of the Invention

The present invention, in some embodiments thereof, relates to the management of sea water or polluted waste water desalination and purification processes and, more particularly, but not exclusively, to methods and system for efficient sea water desalination process execution and management, integrated with electrical power stations, while implementing and using electrical power stations waste hot sea water used for cooling the power generation units, combined with the use of the power station combustion wastes hot gases created by burning of fossils fuels or gases used to create the electrical generator turning power. The present invention relates to solutions intended to improve the usage and the overall energetic efficiency and operational profitability of power stations combined with the reduction of their air pollution, while producing in parallel significant amounts of high quality consumable water in a highly cost efficient way.

Background

Desalination, desalinization or desalting refers to any of several known and implemented processes that remove a substantial amount of salt and other minerals from saline water. More generally, desalination may also refer to the removal of salts and minerals, as in soil desalination. Salt water is desalinated to produce fresh water suitable for human consumption, or for irrigation. One potential byproduct of desalination is salt.

Desalination is also used on many seagoing ships and submarines. Most of the modern interest in desalination is focused on developing cost-effective ways of providing fresh water for human consumption on an industrial and economical scale. Along with recycled wastewater, this is one of the few rainfall-independent future growth potential in the available water sources. Large-scale desalination typically uses large amounts of energy and specialized, expensive infrastructure, making it more expensive than fresh water from conventional sources, such as rivers or groundwater.

Desalination is particularly relevant to countries such as Australia or to semi desert areas like Saudi Arabia and Dubai, which traditionally have relied on collecting rainfall, or drilling for deep earth prehistoric reservoirs to provide their drinking water supplies. According to the International Desalination Association, in 2009, 14,451 desalination plants operated worldwide, producing 59.9 million cubic meters per day, with a year-on-year increase of 12.3%. The production was 68 million m³ in 2010, and expected to reach 120 million m³ by 2020; some 40 million m³ is planned for the Middle East. The world's largest desalination plant is the Jebel Ali Desalination Plant in the United Arab Emirates.

The traditional process used in these operations is vacuum distillation essentially the boiling of water at less than atmospheric pressure and thus a much lower temperature than normal. This is because the boiling of a liquid occurs when the vapor pressure equals the ambient pressure and vapor pressure increases with temperature. Thus, because of the reduced temperature, energy is saved. Multistage flash distillation, a leading method, accounted for 85% of production worldwide in 2004.

The principal competing processes gaining growing market share use membranes to desalinate water, principally applying reverse technology. Membrane processes use semi permeable membranes and pressure to separate salts and metal ions from the saline water. Reverse osmosis plant membrane systems typically use less energy than thermal distillation, which has led to a reduction in overall water desalination operational and supply costs over the past decade. Nevertheless desalination remains energy and infrastructure investment intensive, and future desalinated water production costs will continue to depend on the price of both energy and desalination technology.

There is a growing trend to use electrical power stations waste heat energy to create economic processes of water desalination as a byproduct to the electrical power generation. Such a typical case is a combined thermal power station and a desalination plant for seawater in which the power station includes a gas turbine set, a waste heat boiler connected to the exhaust gas outlet of the gas turbine and a steam turbine. The waste heat boiler includes first and second sections arranged in cascade on the water side in the flow path of the turbine exhaust gases, the first section in the exhaust gas flow path constituting a steam generator for the steam turbine and the second section constituting a source of heat utilized in the desalination plant. Seawater may be passed directly through the second section of the waste heat boiler or high-temperature hot water produced by the second section may be passed through a heat exchanger incorporated in the flow path of the seawater. The waste heat boiler may further include an additional source of heat in the form of a fuel burner for maintaining operation of the steam turbine and desalination plant under emergency conditions in the event the gas turbine set is stopped. Steam turbines are usually employed to operate plants for desalinating seawater, the exhaust steam from the turbines serving as a heat source for the distillation process in that the condenser heats the seawater used as a coolant. (Publication of the Societe Internationale de Dessalement (SIDEM), Paris.

The most economical temperatures for the distillation process lie between about 150.degree and 180.degree C., which corresponds to a back-pressure at the steam turbine of some 5 to 6 bar. In the case of very expensive fuels, relatively high plant costs are still economical, and one can resort to a back-pressure of some 2 to 3 bar, this corresponds to a steam temperature of about 120.degree to 130.degree. C.

It is often more efficient to use a gas turbine instead of a steam turbine as the heat source for the desalination plant, the exhaust gases of the gas turbine being utilized in a heat exchanger to heat high-temperature hot water for the seawater desalination process (Brown Boveri Rev. vol. 54 (1967) p. 9-16). Unfortunately, the temperature of the exhaust gases is very high; in present-day gas turbines it is normally 450.degree.-550.degree C. Lowering this temperature by raising the pressure ratio through the gas turbine would seriously impair the thermal process because output and efficiency of a gas turbine fall sharply when the optimum pressure ratio is exceeded. The exhaust gas temperature is therefore too high for the desalination plant because it results in unacceptably high steam temperatures in the distillation, and hence leads necessarily to unacceptably high steam pressures. The high steam pressures, however, would make the multistage cascade evaporation process very expensive, or indeed impracticable. Furthermore, the high temperatures would cause fouling of the tubes due to the salt contained in the seawater. However, if the temperature of the high-temperature hot water for the distillation process is reduced to about 120.degree.-170.degree. C, the valuable heat at the outlet from the gas turbine is severely degraded owing to increased entropy. One of the objects of the invention cases is to utilize economically the exhaust heat of a gas turbine while retaining the good efficiency of the gas turbine, to which is connected a heat exchanger for supplying heat to a seawater desalination plant.

This object is achieved in that the heat exchanger is in the form of a waste heat boiler with, on the water side, two separate sections of which that section utilizing the high exhaust gas temperatures is used to generate steam for a steam turbine, and the second section constitutes directly or indirectly the heat source for the seawater desalination plant. An improvement in overall thermal efficiency is obtained by combining the gas turbine with a steam turbine. The exhaust gas outlet temperatures from the section of the boiler used to generate steam for the steam turbine are about 180.degree.-200.degree. C, which allows an optimum configuration for the entire steam section. The temperature difference between the two flow media in the steam-generating section of the boiler can then be chosen more favorably, thus making this part of the boiler much cheaper. Heating of the feed water by bled steam can be raised to 150.degree.-170.degree. C, the result of this being that the steam process is improved, the condenser is smaller and the wetness of the steam in the steam turbine is reduced. The lower exhaust gas temperatures after the first boiler section are also very well suited to the second boiler section, which is used to generate high-temperature hot water for the desalination plant or to heat the seawater directly. The overall arrangement permits almost optimum utilization of the fuel. Economically, the combined plant with seawater desalination is superior to either a desalination plant with gas turbines only, or steam turbines only.

Cogeneration is the process of using excess heat from electricity generation for another task: in this case the production of potable water from seawater or brackish groundwater in an integrated, or “dual-purpose”, facility where a power plant provides the energy for desalination. Alternatively, the facility's energy production may be dedicated to the production of potable water (a stand-alone facility), or excess energy may be produced and incorporated into the energy grid (a true cogeneration facility). Cogeneration takes various forms, and theoretically any form of energy production could be used. However, the majority of current and planned cogeneration desalination plants use either fossil fuels or nuclear power as their source of energy. Most plants are located in the Middle East or North Africa, which use their petroleum resources to offset limited water resources. The advantage of dual-purpose facilities is they can be more efficient in energy consumption, thus making desalination a more viable option for drinking water.

In the The Atlanta Journal-Constitution, Nolan Hertel, a professor of nuclear and radiological engineering at Georgia Tech, wrote, “nuclear reactors can be used to produce large amounts of potable water. The process is already in use in a number of places around the world, from India to Japan and Russia. Eight nuclear reactors coupled to desalination plants are operating in Japan alone, nuclear desalination plants could be a source of large amounts of potable water transported by pipelines hundreds of miles inland”

Additionally, the current trend in dual-purpose facilities is hybrid configurations, in which the permeate from a reverse osmosis desalination component is mixed with distillate from thermal desalination. Basically, two or more desalination processes are combined along with power production. Such facilities have already been implemented in Saudi Arabia at Jeddah and Yanbu.

U.S. Pat. No. 5,669,220, Rachid, Sep. 23, 1997, ABB Patent GmbH (Mannheim, Del.) provides a method and a device for operating the water/steam cycle of a thermal power station, which overcome the disadvantages of the known methods and devices of this general type, which are simple and which permit erecting and operating costs of a thermal power station to be reduced. The improvement comprises subjecting the condensate to a pretreatment before reaching the preheating section for dispensing with degassing of the condensate and supplying the condensate to the steam generator without degassing measures being carried out.

It is accordingly an object of that invention to provide a method and a system for operating the water/steam cycle of a thermal power station, which overcomes the disadvantages of the known methods and systems of this general type, which are simple and which permit overall operating costs of a thermal power station to be effectively reduced.

Waste heat driven desalination process described in EP 2516334 A1 (WO2011078907A1) disclosed a process for improving the efficiency of a combined-cycle power generation plant and desalination unit. The process includes supplying exhaust gases from a gas turbine set used to generate electrical power to a heat recovery steam generator (HRSG) and then directing the steam from the HRSG to a steam turbine set. Salinous water is supplied into an effect of the desalination unit. Steam exhausted from the steam turbine set is utilized in the effect of the desalination unit to produce a distillate vapor and brine from the effect by heat exchange. Additionally, steam is introduced steam from at least one additional heat source from the combined-cycle power generation plant to the effect to increase the mass flow rate of steam into the effect. In one embodiment, the additional heat source is an intercooler heat exchanger. Heated water from the intercooler heat exchanger is provided to a reduced atmosphere flash tank, and the steam flashed in the flash tank is provided to the effect.

The use of waste heat from power stations to produce desalinated water is quite known in the prior art. Relevant Patents that serve as examples for such a general hybrid power generation and water desalination approach can be seen in the two patents called Thermal power station combined with a plant for seawater desalination (U.S. Pat. No. 4,094,747 Pfenninger, Filed Jun. 13, 1978. BBC Brown, Boveri & Company Limited (Baden, CH)), and in another such an example of a patent called Method and device for operating the water/steam cycle of a thermal power station, U.S. Pat. No. 5,669,220, Rachid, Sep. 23, 1997, ABB Patent GmbH (Mannheim, Del.)

The use of combined heated sea water and evaporated combustion process released hot gases which are the outcome for the power generation process in power stations using gas turbines, as well as fossil oil based turbines, is described in prior art WO 2009132327 A1, by Paul W. Jepson and EP 2516334 A1. It is also limitedly claimed in prior art patent application number EP20070020424. Still the concept described in details in the prior art number EP 2516334 A1 (WO2011078907A1 and also in less details in number WO 2009132327 A1 it is based on leading the hot pollutant gases into an enclosed chamber possibly with a partial vacuum and to spray into this chamber preheated waste coolant sea water from a power station that by the aid of the hot pollutant gases are being evaporated and then further condensate to create distilled salt less water.

Power generation using steam expansion is a common process. Condensate is fed to a boiler and heated. Steam is removed from the boiler and typically superheated. It then expands across a turbine, thereby doing work. The steam is then condensed and recycled to the boiler. A moderate amount of liquid is intermittently withdrawn from the boiler to prevent sludge accumulation. Treated fresh water is added to the system to compensate for material losses. Dual purpose desalination/power plants currently in use produce fresh water by using the exhaust steam as a source of heat for a distillation unit. Essentially, the power plant's condenser is replaced by the effect of distillation unit. This allows for the efficient production of fresh water.

The present invention and its advantages over the prior art will become apparent upon reading the following detailed description and the appended claims with reference to the accompanying drawings.

### SUMMARY OF THE INVENTION

The following embodiments and aspects thereof are described and illustrated in conjunction with methods and systems, which are meant to be exemplary and illustrative, not limiting in scope. In various embodiments, one or more of the above-described problems have been reduced or eliminated, while other embodiments are directed to other advantageous or improvements.

There is thus a widely-recognized need in the art to have a method and a related system for conducting a new and highly economical water desalination process combined with the reduction of the power station air pollution. The present invention offers an effective utilization of electrical power station waste coolant sea water heat, combined with efficient additional utilization of the lost heat generated through the released combustion gases, that are generated from the electrical power generators turbines and from additional various sources at an electrical power station. The present invention method and system are best fitted in any combined-cycle fossil fuels based power generation plant, to create an add-on low cost and efficient desalination unit, for highly efficient desalination of sea/brackish water—generating very low-cost high purity drinkable water. The new system is characterized by that, that the waste heat sources are the waste coolant sea water generated and driven out in any power station that is cooled by sea or salty water. The invention method is implementing the combined use for further heating the waste heated sea water by the flue-exhaust gases, released out of the combustion process of fossil fuels at the power station, such as Fuel Oils, Heavy fuel oils, Diesel oils, Coal, Lignite, Natural gas, and also by additionally using the heat present in furnace exhaust gas and flared hydrocarbon gases if available at the site.

The invention new effective efficient water desalination process method is comprising of the following main inventive steps; a. Collecting in a dedicated first container and using preheated power station wasted heat sea water of typical 70-80 Deg. C., that were previously used to cool the turbines in a power station and then drained out to be further the sea; b. Releasing super heated combustion waste process gas directly from a power generating turbine or from the chimney, of a typical temp of typical 180-200 Deg. C. into said liquid container containing said waste heat sea water, while in said process hot gas is released into said waste heat preheated sea water through a large area network of mini/micro nozzles piping matrix immersed and situated close to the bottom of said dedicated sea water container, thus releasing said gas in the shape of miniature bubbles of a typical controlled mini and microspheres size to permeate through said preheated sea water layer. Through this permeation process said hot combustion released gas miniature bubbles absorb and contain in them a hi quantity content of water vapors as they move up through said preheated seawater layer(s) and at the same time pollutant gases contained in the combustion gas bubbles passing through the much colder sea water are dissolved in the sea water and the heavy particles and material such as heavy metals and sulfurs, contained in the combustion generated gases are precipitating to the lower part of the bubbling process sea water container and then pumped out as a slime to be further disposed; c. The super heated gas bubbles containing a high content of water vapors and the combustion process gases are emerging out of said pre-heated sea water layer and the residual pollutant gases encapsulated in said micro bubbles are then released to the air through a set of filters and then to the atmosphere; d. The water steam content is further cooled while said gas bubbles water vapors content is released and condensed through a cooling process into pure water droplets accumulated on the internal surfaces of a second cooled container and on the surfaces of a cooled heat exchanger, while the cooled heat exchanger is being cooled by the internal circulation of natural deep sea water with typical temp of 10-20 Deg C; and e. The purified condensed water vapors water droplets while accumulated on the surfaces of the invention system heat exchanger are self collected by gravity from the surfaces of a special heat exchanger and pumped to a reservoir containing purified desalinated water for further use.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a schematic flow chart illustration of a state machine wherein states reflect actions and processes while transition arrows relate to internal or external triggers, which are performed with regard to a certain system layout, according to one embodiment of the present invention, wherein this state machine is demonstrating a water desalination system multi-step functions and the related operational method according to the present invention;

FIG. 2 is a schematic illustration of a combined waste sea water and waste combustion gases heat recycling integrated into a low cost and energy consumption efficient water desalination system and process according to some embodiments of the present invention;

FIG. 2A is a schematic illustration of a two stages combined waste sea water and waste combustion gases heat recycling integrated into a low cost and energy consumption efficient water desalination system and process according to another embodiment of the present invention;

FIG. 2B is a schematic illustration of a two stages combined waste sea water and waste combustion gases heat recycling integrated into a low cost and energy consumption efficient water desalination system and process according to another embodiment of the present invention wherein the desalinated sea water is going through an additional purification process combined of a multistage chemical filtering and a reverse osmosis final purification stage to achieve a high quality drinkable water production;

FIG. 3 is a schematic illustration according to another embodiment of the present invention combined waste sea water and waste combustion gases heat recycling integrated into a low cost and energy consumption efficient water desalination system and process, wherein the creation of both evaporated water steam and the steam condensation in two separated stages are both done through the invention two dimensional array of perforated vertical tubes;

FIG. 4 is a schematic illustration according to another embodiment of the present invention combined waste sea water and waste combustion gases heat recycling, integrated into a low cost and energy consumption efficient water desalination system and process, wherein the creation of both evaporated water steam and the steam condensation are done in a single unit first water evaporation container enclosed within a second steam to water condensation container, wherein the two separated stages are both done through the invention two dimensional arrays of gas and air injection nozzles;

FIG. 5 is an illustration of portable apparatus according to yet another embodiment of the present invention, wherein a cost effective salty water desalination, evaporation based process, is supported by combined utilization of water boiling and evaporation by electrical heating, further heated to create steam by harnessing solar radiation energy, or by circulation in a heat exchanger waste heat from any accessible industrial or central heating/cooling processes, said embodiment is also characterized by the use of a special heat exchanger and condensation unit combined of a multiple of perforated vertical pipes equipped with an array of hot steam spraying nozzles.

### DETAILED DESCRIPTION OF EMBODIMENTS OF THE INVENTION

The present invention, in some embodiments thereof, relates to water desalination and, more particularly, but not exclusively, to methods and system of cost effective and efficient water desalination when combined with an electrical power generation process.

Before explaining at least one embodiment of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or a process. Accordingly, aspects of the present invention may take the form of an entirely hardware embodiment, or an embodiment combining process and hardware aspects that may all generally be referred to herein as “module” or “system.” Furthermore, aspects of the present invention may include a computer program product for managing and controlling the invention system embodied in one or more computer readable medium(s) having computer readable program code embodied thereon.

Preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article, system or apparatus.

The singular forms “a,” “an” and “the” include plural referents unless the context clearly dictates otherwise.

Aspects of the present invention are described below with reference to flowchart illustrations and/or block diagrams of methods, systems and computer control program products according to some embodiments of the invention. It will be understood that each block of the flowchart illustrations and/or block diagrams, and combinations of blocks in the flowchart illustrations and/or block diagrams, can be controlled by computer program instructions. These computer program instructions may be provided to a processor of a general purpose computer, special purpose computer, or other programmable data processing apparatus to control a process, such that the instructions, which execute via the processor of the computer or other programmable data processing apparatus, create means for implementing the functions/acts specified in the flowchart and/or block diagram block or blocks.

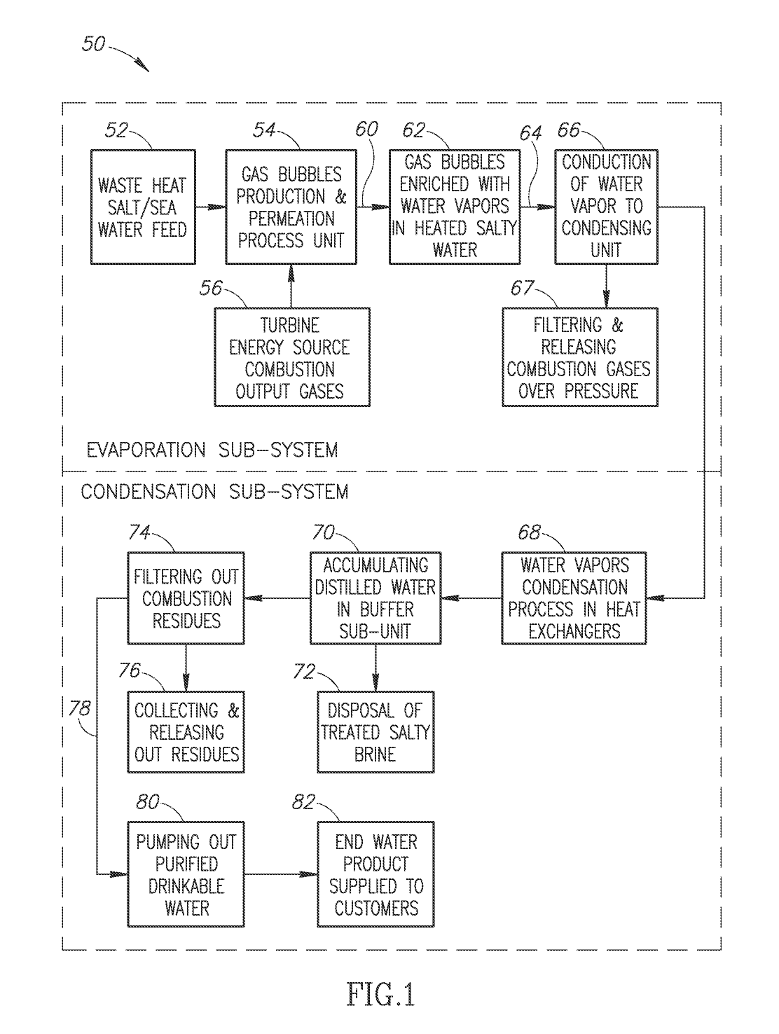

Reference is now made to FIG. 1, which is a schematic flow chart illustration of a state machine 50, wherein states reflect actions and processes while transition arrows relate to internal or external triggers, which are performed with regard to a certain system components layout, according to some embodiments of the present invention, wherein this state machine is demonstrating a water desalination system multi-step functional modules and the related operational method according to some embodiments of the present invention. Stage 52 contains the stage of filling into the present invention system first water evaporation unit container with the hot waste cooling sea water from the electrical power plant. In stage 54 the first invention system container is getting a second input feed of a highly heated (typical 200-400° C.) exhaust gas derived from the oils, coal or natural gas combustion post process residual gases driving the electrical power generator turbine 56. In stage 54 the combustion exhaust gas mixture input 56, coming from the electrical turbine, is fed through sub-process transition stage 60 into the present invention dedicated gas bubbles generation device which is installed in the first container evaporation unit. The exhaust gas mixture output coming out of the dedicated bubbles generation device is continuously permeated into the hot waste sea water while creating a highly dense cloud of mixed waste gas and water steam bubbles, each such bubble containing a hot mixture of gas, water and steam content as a floating bubble, created through a very large two dimensional array of micro and sub millimeter size nozzles that is an integral part of the invention dedicated device which is immersed in the evaporation container hot salty sea water that gets the residual gases as an input and releases to the hot salty water in the invention evaporation container a cloud of mini and micro bubbles in a controlled gas and steam multi-bubbles cloud shape structure. In stage 62 the dense cloud shape of a large multiple of bubbles, each containing a mixture of exhaust gases and water steam generated by fast heating and water steam evaporation of the salty water engulfing each such permeated gas bubble moving up in the salty hot waste heat sea water container, In the transitional process 64 marked as an arrow between stages 62 and 66, the mixed gases bubbles are floating up through the hot waste sea water in the evaporation container of the present invention until they reach the upper air level above the sea water content level in said first evaporation container and then further accumulated and conducted in stage 66 to the condensation container which is containing the condensation sub system and process of the present invention water desalination method and system. Stage 67 is including a parallel process to stage 66 where the over exhaust gas pressure, that is created by the release of the accumulated combustion gases in the top level of the first evaporation container is filtered to hold the water vapors content and release the pollutant gases content of the combustion gases that were fed into the first container in stage 56. In stage 68 the output containing a mix of water steam and water vapors of the first evaporation container is fed into a cooling and water vapor condensing heat exchanger that is an integral part of the second condensation container and desalination sub-system. In stage 70 the cooled down water droplets on the surfaces of the heat exchanger and on the inner walls of the second condensation container are dropping down by gravity force to accumulate in stage 70 in a desalinated water buffer subunit. In parallel in the first sea water container in stage 72, the high salt content brine layer created by continuous evaporation of clear water from the residual sea water is slowly precipitating and accumulating at the bottom of the first evaporation container and by gravitation is accumulated into a brine collection container at the very bottom of the first container. In stage 74 the droplets of the desalinated salt-less water are accumulated by gravity in a lower level container under the second condensation level container during transition process 78 the desalinated water are slowly accumulated in stage 80 the desalinated water and in stage 82 they are pumped out and further distributed to the various desalinated water clients.

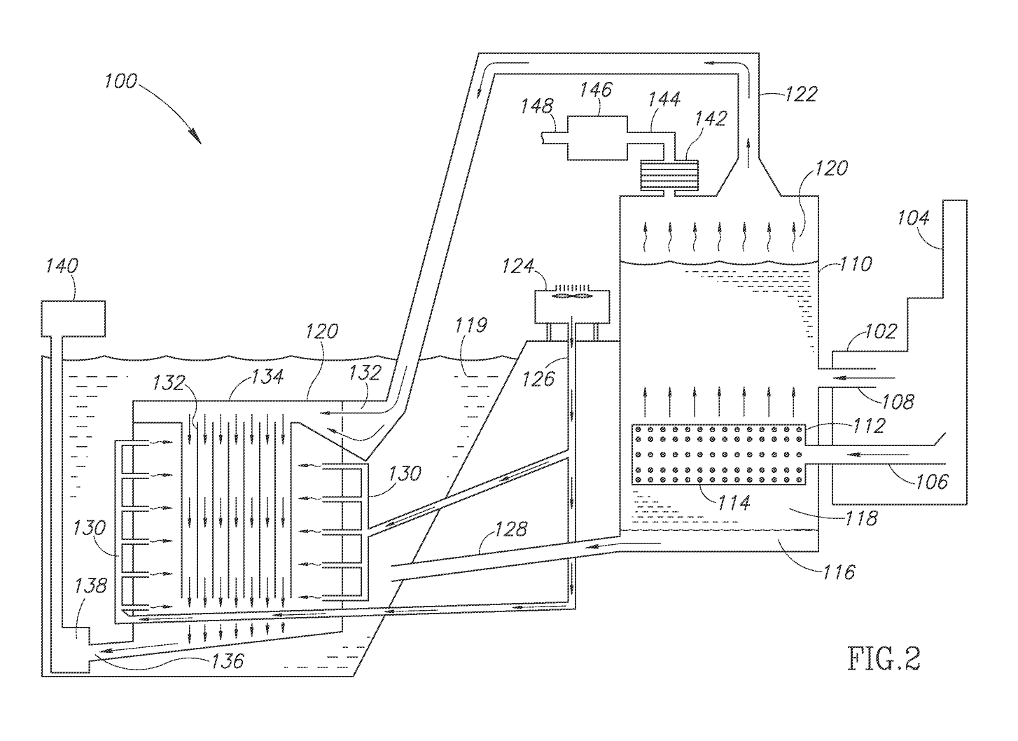

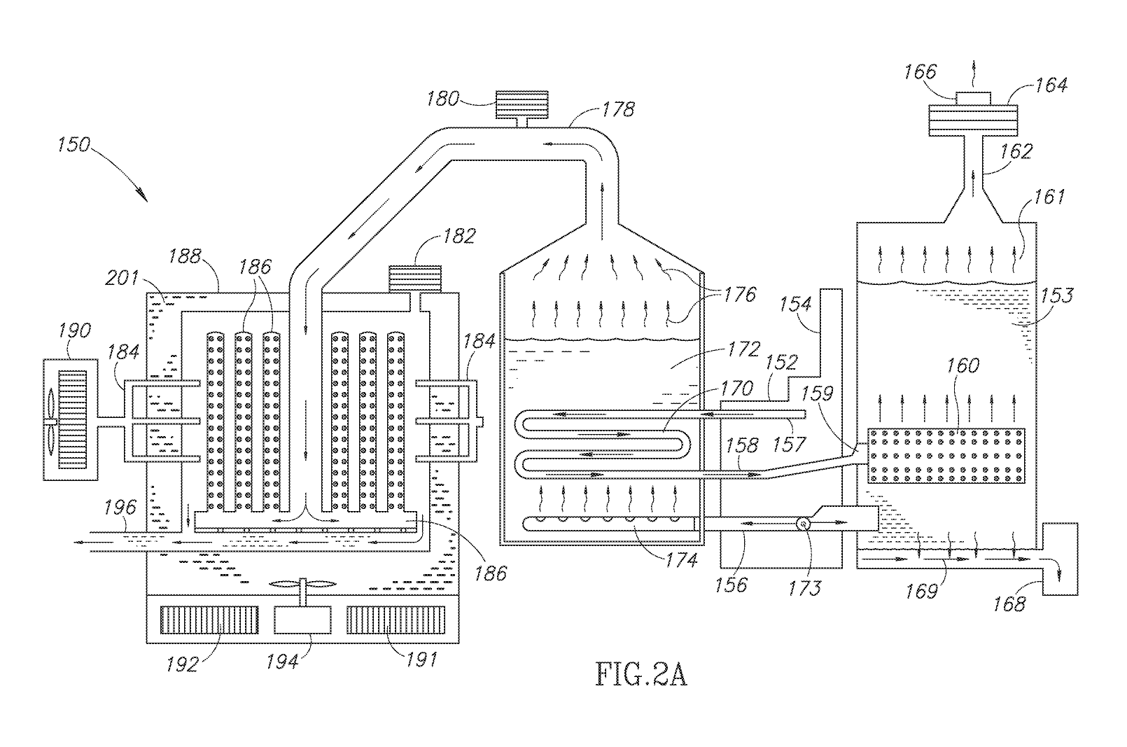

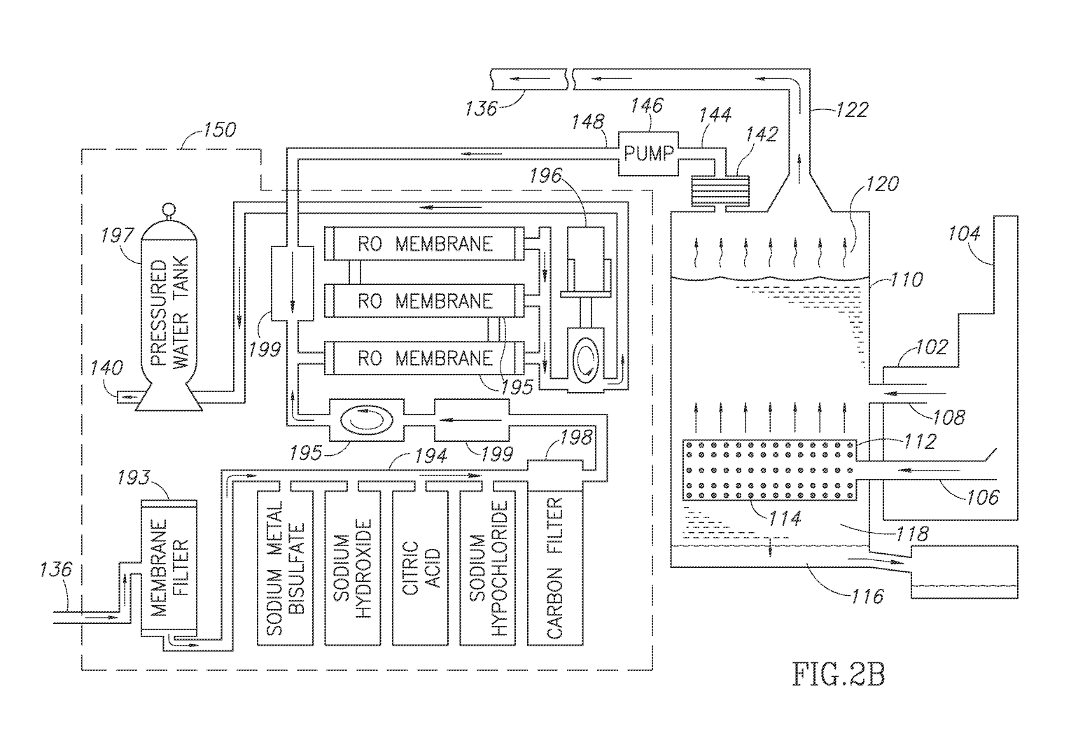

Reference is now made to FIG. 2, which is a schematic illustration of an exemplary combined-cycle power generation plant and desalination unit 100 that includes an electrical power generation plant 102 and an annexed thermal desalination unit combined set to two units, unit 110 is the evaporation sub unit and unit 120 is the water condensation subunit. Several embodiments of the invention reduce displaced electricity from the combined cycle plant by utilizing waste heat streams for the invention thermal desalination. In the illustrated embodiment, the power generation plant 102 may include a conventional fossil fuel based steam operated generator or it may include a gas turbine plant with a heat recovery portion that includes a heat recovery steam generators (HRSG). Although the embodiments herein use waste heat from the fossil fuels heated steam based turbine or a gas turbine power plant 102 to drive the desired desalination process, one skilled in the art will understand that the invention can also utilize the waste heat from industrial processes or from any type of power plant such as fossil-fired boilers, biomass-fired boilers, waste recovery boilers, waste incinerating furnaces, nuclear boilers, fuel cell power plants, geothermal sources, and solar sources.

In the exemplary embodiment, the electrical power plant 104 includes a hot waste cooling salty sea water output 108 fed to the invention desalination system first container 110 and a second waste combustion gas output source 106, also fed to the invention desalination system first container 110. A dedicated gas bubbles generation device 114 which is installed in the first container evaporation unit 110 and deeply immersed in its hot salty sea water, is made of a densely perforated close end pipe or a metal mesh sleeve that gets as the input the waste combustion gas from the power plant 104 through the feeding inlet 106 and due to its unique structure creates a large plurality of micro and sub millimeter size gas bubbles to be continuously released as a cloud of a large multiple of bubbles into the hot waste sea water 118 which is contained within the major lower part of the volume of the invention first evaporation container 110. The hot gas bubbles (typically 180-220 degrees C.) while in direct contact with hot sea water (typically 70-80 degrees C.) create an immediate effect of boiling and evaporation of the sea water surrounding each such bubble, thus each such bubble then contains a mixture of the waste cooler gas together with steam and hot water vapors extracted from the instantly boiled and steamed hot sea water surrounding each such bubble. These mixed gas and water steam bubbles are permeating upwards through the entire content of the first sea water evaporation container 110 until they reach the hot sea water air filled level 120 at the top of the container 110. At this top level part 120 of the container 110 the heavy in volume content mix of water vapors and the steam released from the surfacing cloud of mixed content bubbles is collected and directed to the second container 134 for further processing through the hood and pipe structure 122. The much lighter in volume exhaust gas output component is released and accumulating at the higher level of the volume 120 at the top of container 110. This released hot gas component derived from the mixed gas and water steam cloud of the continuously surfacing bubbles is creating a high pressure at the top of the first container 110 where it is planned to be released out of the system while continuously filtering it out through a dedicated cooling heat exchanger 142, a conduction pipe 144 and a special toxic chemicals absorbing filter 146 after which this cooled gas is related through a chimney 148 to the open atmosphere at a much lower temperature and with much lower pollutant content than its original content and temperature at the 106 waste combustion gas inlet pipe. In parallel the evaporated heavy metal vapors and various mineral vapors contained in the original combustion gas coming through combustion waste gas input of first container 100 inlet 106, is cooled down during the bubbling and permeation process and then transforming back in to solids or semi solids phase, where due to its high gravity weight, when compared to the surrounding sea water, is slowly precipitating and accumulating at the bottom of 110, where the lower pollutant materials accumulation part 116 of the evaporation container 110 is situated. From this 116 waste pollutant accumulating part the mixture of brine of salts and metals is pumped and released to the depth of the sea through waste process drainage unit and pipe 128.

The mixed steam and hot water vapors hot gas composition is conducted through a piping sub-system 122 to a second condenser container unit 120 immersed at the cooler water depth (5-20 meter deep) of the sea or lake water, which should be adjacent to the power station 104 that is demanded to be annexed to the invention desalination system composed of units 110 and 120. Module 132 is the steam and vapors mix first step cooling unit, built as a serpentine type gas to liquid heat exchanger where the mixed hot water steam and vapors is being cooled down by the cold seawater while passing through the heat exchanger as the gas-cooling unit 132 is immersed in the open sea colder water 119.

Unit 134 is the second container and sub system serving for the evaporated salt free water condensation process, wherein the cooler yet still hot mixture of hot water steam and vapors is passing through a multiple of air gaps created by and between a multiple of parallel spaced vertical metal plates, or through the inner volume of a multiple of parallel vertical metal tubes 132, that are constantly cooled down by the orthogonal blow of cold air supplied by a dense array of air nozzles 130 surrounding the array of parallel interspaced metal condensation plates or tubes 132. The cooled air supplied to the nozzles array 130 is coming through an air conduction array of ducts and pipes 126 leading the cooling air to the array of nozzles 130 from a combined fan plus air cooler unit 124, which uses an open atmosphere air as the input to an air suction and blower unit, while further passing in 124 the extracted atmospheric air through an integrated active air cooler unit in 124, that is based on a condensed gas expansion module, similar to those used to cool the air in central air-conditioning systems. The cold air blow from a large multiple of air spray nozzles is cooling the metal plates or tubes metal walls, but also the air volume containing the passing through mixture of water steam and vapors flowing between the metal plated or within the inner volumes of the parallel metal tubes 132.

The enforced orthogonal blow of cold air, coming through the multiple nozzles array 130, is causing the mixture of steam and water vapors to condensate and accumulate as fresh water droplets on the 132 metal plate surfaces or on the metal tubes array inner walls. These condensed water droplets then slide down by gravitation on the vertical plates or tubes metal planes and accumulate by gravity in a special sloppy bottom fresh water collection container 136 that is situated and fixed on the lower level of the fresh desalinated condensation container 136. Unit 138 is a lower sea level container accumulating and storing the desalination system purified water output. Output unit 140 is combined of water pump and an above sea level consumable water supply container unit 140. The system is capable of pumping up to unit 140 from unit 138 the accumulated desalination system desalinated water output and then provide usable consumable water through 140 to be connected directly to the consumers water supply piping grids.

Reference is now made to FIG. 2A, which is a schematic illustration of an exemplary another embodiment of the present invention combined-cycle power generation plant and desalination unit 150, that includes an electrical power generation plant 154 and 152 and an annexed thermal desalination unit combined set to three units; unit 172 is the evaporation sub unit, unit 188 is the water condensation subunit and unit 153 is the present embodiment system waste combustion gas pollutants content filtering and reduction third unit. In this embodiment the electrical power plant 154 combustion process waste released pollutant gas is not directly mixed with the waste hot sea water to create the desalination process, but the two processes are separated. The waste combustion process gas is first flowing from the power station 152 section to a feeding pipe 157 and then flowing through a gas to water heat exchanger 170 which is immersed in the first evaporation container 172 to then further heat up the waste heat hot seawater contained in 172 to a boiling level, thus creating a steam generation process by fast water evaporation and steam released output layer accumulating above the level of the heated waste sea water in container 172. The waste heat hot sea water is fed to the evaporation unit 172 through a hot sea water pumping unit 173, which is situated within the power station 152, then the hot combustion released waste gas is conducted through the pipes 156 to a hot sea water release distribution subunit 174 immersed in the sea water and installed at the bottom level of the evaporation container 172. The one step cooler combustion waste gas flowing through and out of the heat exchanger 170 is then further conducted out of unit 172 through the hot gas output piping subunit 158, into the third container 153 that is also containing said waste heat hot sea water pumped and fed into the third unit 153 by the hot waste heat salty sea water pump 173 situated in the power station 152. The one step cooler hot waste combustion gas coming out from the gas to water heat exchanger unit 170 and fed into third container 153 by the gas conduction piping unit 158, is then fed into a dedicated gas to water micro and mini size bubbles release unit 159, where the hot waste combustion gas is slowly released as a cloud of miniature gas bubbles into the comparatively cooler waste heat sea water which is contained in the third container 153. The hotter waste gas is released to the less hot waste heat sea water through the bubbles release unit 159 containing a dedicated mesh creating a large area two dimensional network arrays 160 of mini/micro size nozzles. The already one step cooled down waste combustion gas bubbling process created by passing through the arrays 160 of mini/micro size nozzles, the released gas very large multiple of bubbles are then permeating upwards through the thick layer of waste heat sea water while through this process most of the combustion process waste gas contaminating ingredients contained in those gas bubbles are dissolved into the heated sea water in the third container 153 and then further cooled down and slowly precipitating down into the third container 143 lower level wherein above its bottom there is a slime and pollutants accumulation container unit 169, from where the contaminating ingredients are extracted as a brine slurry and being further pumped by unit 168 out of the third container 153. The combustion waste gas that was further cooled down when released as gas bubbles in water, is then accumulating in the upper level 161 of the third container unit 153 from where it is further collected and released through a gas collection hood unit 162, passing through an advanced gas cleaning filter 164 that is geared to further reduce contaminating materials and co2 content in the processed gas and then leading the processed gas to a chimney 166 finally leading it to the open atmosphere, the final released gas in this process is then containing much less contamination pollutant ingredients in it than in any other standard and conventional fossil fuels combustion based electrical power station.

In parallel the steam level water vapors created in the first container 172 are led and conducted through water steam ducts 178 to be then further condensed into desalinated water stage in a condensation process conducted and managed in the second condensation container 188. The condensation of the steamed water coming through the ducts 178 is done by conducting the steam down and then up through a dedicated steam cooling heat exchanger 186, which is integrated and installed within an special condensation stage air filled container which is installed within the second container 188. The special steam heat exchanger 186 is constructed from a two dimensional matrix array of vertical perforated tubes, which are closed in their upper ends, while these tubes are perforated with sub-millimeter dense array of nozzles or holes around each of these vertical tubes perimeter and along their length. The steam coming from steam ducts 178 is streaming and enforced into the inner volumes of the array of perforated tubes, while the steam is fed into them from their lower open ends into the inner volume of these vertical perforated tubes array and then the steam is released out from these tubes through the perforated array of nozzles in of vertical tubes to the air volume of the internal condensation container air volume. The well distributed steam cloud coming out of the multiple nozzles in 186 is then being quickly cooled down by forced and further cooled down fresh air, pumped from an orthogonal array of air nozzles which construct the cooling air release unit 184, streaming on the steam conducting perorated tubes grid with a plurality of ending steam release nozzles. The cool air is pumped into the internal air filled condensation container which is situated within the 188 second container air volume and wherein the steam is then further condensed to tiny water droplets spray in the air and wherein these water droplets being further accumulated on the inner surfaces of the internal air filled condensation internal condensation container installed within second container 188. The internal air and steam filled condensation container is therefore further cooled down and then its internal steam content within the enclosed volume is further condensing into water droplets on the internal cooled condensation container walls. The condensation container surrounding cooling cold water content 210 is constantly circulated by a fresh non salty water 194 impellor circulating the entire water 201 content that is filling the space volume created between the internal condensation air filled container and the external second container 188. 191 and 192 air inlets are connected by an air ducts to an active water cooling system within the lower part of container 188 that is cooling the entire volume of the water 201 content. The condensed desalinated water drops are then slowly sliding down by gravity on the condensation container walls and then accumulated into the water duct 196 and is conducting and leading out the desalinated water volume, out of the second container 188 and into the consumable water grid system. In another similar embodiment of the invention the output still hot gas coming out of the chimney 166 may be fad back to the hot gas inlet 157 of the heat exchanger 170 to further enhance the efficiency of using the combustion process released waste gas to heat the sea water to reach faster the required steam generation water boiling stage.

Reference is now made to FIG. 2B, which is a schematic illustration of an exemplary another embodiment of the present invention combined-cycle power generation plant and desalination unit 100, that includes an electrical power generation plant 104 and 102 and an annexed thermal desalination unit, combined of a set of three units; unit 110 is the evaporation sub unit as described in FIG. 2 and unit 120 is the water condensation subunit as also described in FIG. 2, but in this embodiment there is an additional third unit 150 that creates a deferent embodiment of the invention system that treats some side effects related to dealing with the waste combustion gas pollutants content residues filtering and the gas possible chemical contents reduction in the desalinated water by integrating the third unit 150. In this embodiment the electrical power plant 104 oils or other fossils burning or combustion process wasted and released pollutant gas is causing a high content of pollutants in the released combustions gases and therefore the use of this waste gas to further creation of more sea water based stem is providing distilled that are not highly clean of chemical and meal toxic residues. In this embodiment therefore the desalinated water is created by accumulated condensed water droplets collected by gravity from the surfaces of the 134 heat exchanger and further accumulated in the water reservoir 136 containing the condensed desalinated water, is further filtered, purified and processed in a third active filtering unit 150 to get very high quality drinkable water. This additional supplementary process is composed of the following steps, done in a set of dedicated active filtering sub-stations. At the first substation of the filtering and water purification unit 150, the desalinated water accumulated in container 136 which situated at the bottom of container 120, are pumped and filtered from some contaminants while passing through unit 140 (as shown in FIG. 2.) The filtering process is done by a membrane filter 193 that its task is to filter out and clean all residual particles and contaminating non solvent ingredients that still left in the desalinated water, that were accumulated in the desalinated water container 136. The second filtering substation is done on the desalinated water while passing through a set of chemical filters 194, wherein the desalinated water that may still contain residual combustion gas pollutant chemicals and heavy metals, are then passing through a series of chemicals which are contained in a series of serial containers 194 wherein these chemicals are reacting one after the other with the pollutant chemicals and heavy metals residues that might still be found in the desalinated water, that are then reacting as reactive and absorbing filters that will react and absorb all still existing residual contaminating chemicals and material still dissolved in the desalinated water, said absorbing and actively reactive materials in said reactive filters are selected from the materials group including at least Sodium Metal Bi-sulfate, Sodium Hydroxide, Citric acid and Sodium Hypochlorite. In the following third water purification sub-unit, the chemically filtered desalinated water is then going through a Carbon filter 198, to get rid of all live organisms and organic molecules and residues. The carbon filtered desalinated water is then further pumped, passing going through a one direction valve 199 and a pulsating water high pressurizing pump 195 to be fed into an pressure enforced reverse osmosis process subsystem. The reverse osmosis (RO) subsystem (containing modules 188, 195,196, 199) contains at least two or more reverse osmosis cylinder filter units 188, wherein one such filter being connected to the other in series and wherein the output of each one of the RO filters 188 is fed to the water inlet of the other RO filter 188. In each of the reverse osmosis cylinder filter serial 188 units the desalinated water are pressurized inside the inner membrane tube and the pressurized water is permeating through the selective inner tube membrane that is passing through only water molecules and filtering out all other molecules. The desalinated water inlet to the RO multi tube structured sub-system 188 is further pressurized to boost the reverse osmosis process efficiency, by feeding to the RO 188 water inlet the released gas high pressure emerging out from the evaporation container 110 after being filtered by filter unit 142 and further pressure boosted by booster pump 146 to be then further led by a piping sub-system 148 to the RO sub-system 188 through a one direction valve 199 to avoid water coming from pump 195 to reverse through piping sub-system 148 into the evaporation first container 110. Following the final RO based desalinated water filtration and purification stage the purified desalinated water output is then pumped by suction pump 196 and fed into a pressurized water tank 197 from where fresh drinkable water are supplied through output outlet pipe 140, as also appears in FIG. 2.

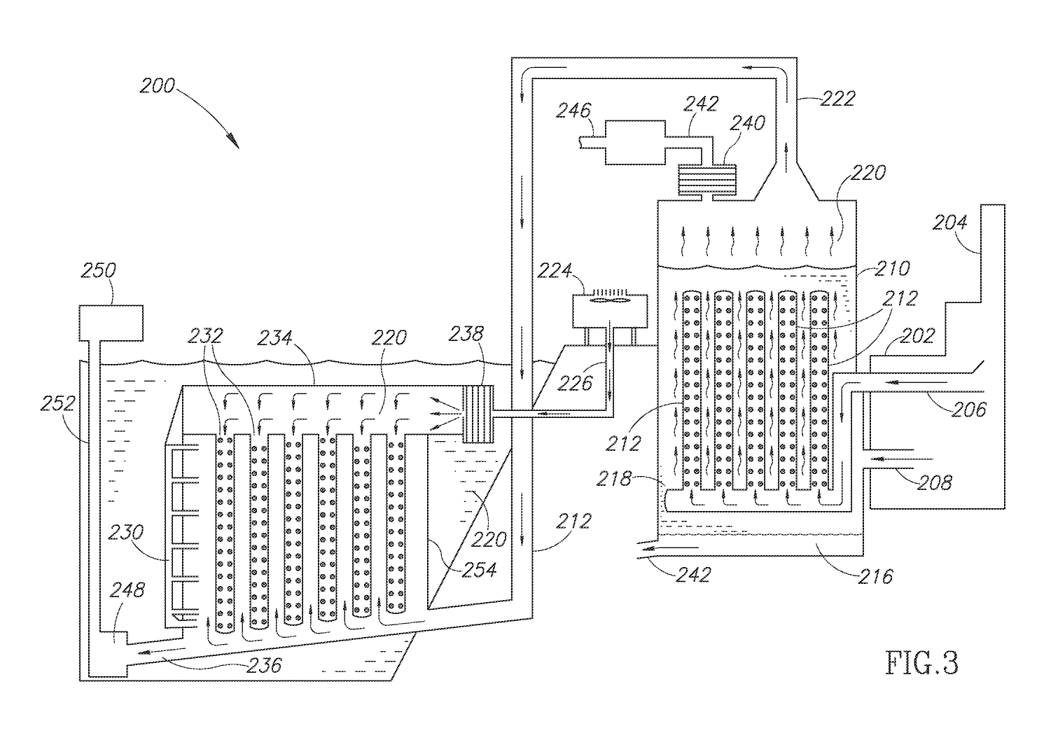

Reference is now made to FIG. 3, which is a schematic illustration of an exemplary another embodiment of the present invention process and system of a combined-cycle power generation plant and desalination unit 200, that includes an electrical power generation plant 204 and 202 and an annexed thermal desalination unit, which is further combined of a set of two units; unit 210 is the evaporation sub unit and unit 234 is the water condensation subunit. In this embodiment the first sea hot water container 210 is containing a special gas permeation unit where the waste combustion process gas input 206 fed into the first container 210 is streaming and by itself pressure is enforced into the inner volumes of a two dimensional array 212 of perforated vertical tubes with a closed upper cap. The gas flowing into the array of tubes 212 is entering from their lower open end and is pressurized into the inner volume of these vertical perforated tubes 212 and then released out through the multiple area of perforated gas nozzles in the array 212 of vertical tubes. The combustion gas coming from 206 permeates as gas bubbles into the first container 210, filled with hot sea water to create a high release rate of up raising condensed volume of miniature gas bubbles wherein the bubbles are highly enriched with water vapors and water steam. The water vapors and water steam are then further released to the air volume in the upper level of the first container 210 and then the steam and vapors are led through a steam conducting pipe 222 to a second condensation container 234, wherein the steam and water vapors are condensed to provide a volume of desalinated water.

One of the invention dedicated gas to gas cooling heat exchanger embodiments which is part of the second air filled container 234, is also constructed from a similar two dimensional matrix array of vertical tubes 232, which in this array embodiment are closed in their lower ends and wherein this heat exchanger 232 tubes are perforated with sub-millimeter dense array of nozzles or holes around each of said vertical tubes perimeter and along their length. The combined mix of water vapors and steam coming through steam mixture conduction ducts 222 is then further streaming through the colder deep sea within the immersed water air to water multiple piping based exchanger 212, which serves as a steam cooling heat exchanger, that is also serving for further leading the steam mix from the first container 210 to the second container 234, that is equipped with this special array of tubes 232. A multiple stream of cold air coming from an open air pump 224 is further cooled down by the sea water immersed heat exchanger 238 that is further pressurized in a down side diverted cold air flow 220 into the array of perforated tubes 232 wherein the pressurized cold air is then emerging from the array of multiple nozzles in the tube array 232. In parallel the flow of steam and water vapor mix that coming to container 234 through pipes network 212 is injected into the second container 234 internal volume and flowing in the open air gaps that is created between the vertical perforated tubes 234. This steam mix flow is then being cooled down and further condensed on the outer surfaces of the plurality of perforated metal tubes 232 as the injected steam and water vapor mix is effectively also further cooled down by a plurality of multiple cold air jet streams of forced and cooled air injected from the large plurality of cold air jets that is emerging for the plurality of cold air nozzles 230, said cold air jets are being fed into said air injection nozzles 230 are also fed from the flow of cold air 220. The water vapors and steam mixture, after being fast cooled down by the cold air streams is then condensing on the multiple perforated cold tubes outer surfaces to create a down falling flow of a large volume of condensed miniature water droplets that are accumulated also on the container 234 walls 254. All these water drops are then falling on the second container 234 sloped floor 236 to be then further dripping down along the slopes of 236 when the accumulated desalinated and condensed water droplets are being further flowing downwards by gravity on the lower near base level of the second container to be further accumulated at a lower ground level, end of process desalinated water tank container 248. From this desalinated water container 248 immersed in deep sea level, the desalinated water is then pumped up to above sea level through pipes 252 by a combined water pump and an above sea level water distribution container 250.

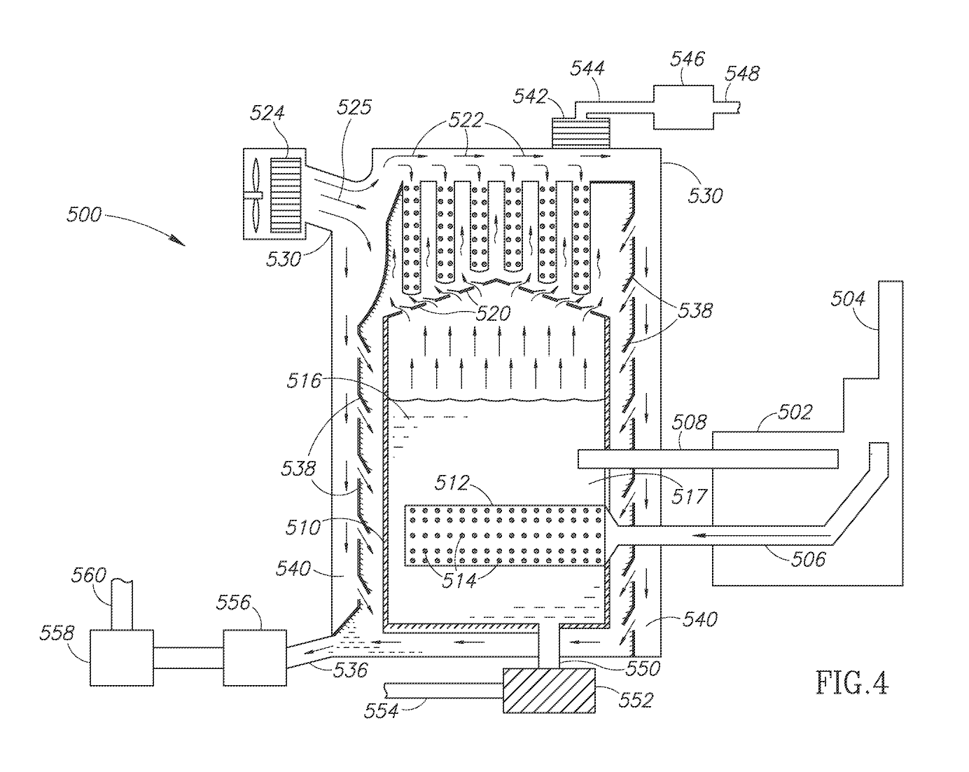

Reference is now made to FIG. 4, which is a schematic illustration of an exemplary another embodiment of the present invention combined-cycle power generation plant and desalination unit 500, that includes an electrical power generation plant 504 and 502 and an annexed thermal desalination unit, combined of a set of three one in one structured units; unit 510 is the evaporation sub unit and unit 538 is the water condensation subunit, yet in this embodiment there is an additional third external envelope containing unit 530 that creates a different embodiment of the invention system that treats some side effects related to dealing with the large size and dimensions of the other present invention possible embodiments regarding the invention desalination system that in other embodiments of the invention is based on a 2-3 dedicated containers separation concept and wherein the condensation units are also immersed inside the sea water, that requires the design and use of special anti corrosion building materials and also highly demanding operational constraints. The system of this embodiment as described in the associate figure drawing is demonstrating another embodiment of the present invention wherein the first and the second containers functions are merged into a one unified, one inside one container, wherein the first evaporation container 510 is encased within the second condensation container 538. This embodiment is enabling a compact, all on land desalination system design, a simple construction and the economical and convenient operation of a desalination system according to the present invention. The first internal container 510 is containing the gas bubbles generation mesh structured sleeve device 512 that is comprising of a supporting gas release structure and mechanism containing large area network arrays of mini/micro size nozzles, while this devise 512 is immersed in the waste hot sea water which is contained within the first container 510. The waste combustion process gas input 506 is also fed into the first container 510 gas babbling device 512 and permeates through the multiple micro holes 514 through waste sea water as a hot gas and steam combined mixture encased within bubbles all flowing up towards the higher air filled part of the internal container 510. The power station 504 waste combustion process gas input being fed through piping 506 into the first container 510 then permeates through the hot waste sea water as a hot gas and steam combined mixture encased within a multiple bubbles structure, all flowing up in the hot sea water 516 to finally reach the higher air filled part of said first container. The gas containing bubbles are created through the gas release device 512 that is containing large area network arrays of mini/micro size nozzles immersed in the sea water 516 volume which is contained in the first container 510. The mix of waste process gas and steam within the containing bubbles is released when these bubbles are reaching the sea water surface level in container 510 and convert to a steam and vapors mix condensed volume in the form of a cloud of bubbles volume, is emerging through and out of the first container 512 upper cover roof tiles and their intermediate output slits 520 that are structured, integrated and enclosed in the first container 510 upper cap. The bubbles content of gas and steam mixture is then emerging out of container 510 exiting it thought the slits that are between the first container 510 roof tiles 520 are the entering into the volume of the second air filled volume container 538, which is containing in itself also the first container. The vapors and steam emerging mixture is entering into the space volume of cooling heat exchanger that is installed within the second air filled container 538, which is constructed from a two dimensional matrix array of vertical tubes which are closed in their lower ends, said tubes are perforated with sub-millimeter dense array of nozzles or holes around each of said vertical tubes perimeter and along their length;

The water vapors and steam mix that is up streaming from the first container 510 are penetrating and going up in between the perforated tubes that are located in the upper end of the condensation container 538, then in the second container 538 it is flowing in the open air gaps between the vertical perforated tubes, wherein it is being cooled down and further condensed on these plurality of perforated tubes by a plurality of streams of forced cooled air injected from the large plurality of cold air jets emerging for the plurality of cold air nozzles that are in these perforated tubes. The steam cooling cold air blow is generated by the air blower and air cooler unit 524, where the generated blow of cold air 522 being fed into these vertical tubes from their upper opened end, and pressurized into the inner volume of each such vertical perforated tube. At the following stage the water vapors and steam mixture is cooled down and condensed on the multiple perforated cold tubes outer surfaces and on the inner corrugated surfaces of the seconds condensation container 538, where it create a high rate of down falling flow of a volume of condensed miniature water droplets. The water droplets accumulated on the perforated tubes outside envelop are all falling on the first container upper roof tiles structure cover 520, to be then further dripping along the slopes of said roof tile structured cover. The water droplets are then being further accumulated by gravity on the lower near base level of the second container 536 to be further accumulated at a lower ground level, passing through an end of process desalinated water filter 556 and then accumulated in the desalinated water end product accumulating tank 558. The slime content of condensed salty water brine is accumulation during the evaporation process at the bottom of container 510 from where it is accumulating through pipe 550 into container 552 and pumped out of the system through pipe 554.

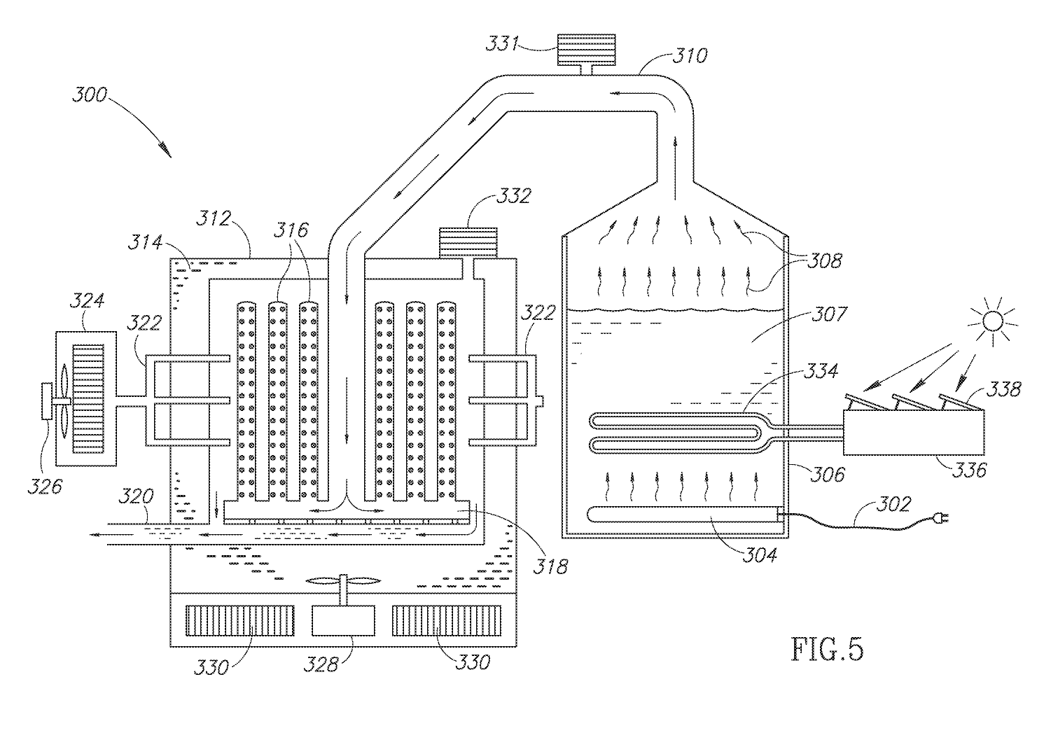

Reference is now made to FIG. 5 which is an illustration of an example of an apparatus of the present invention, providing a portable cost effective salty water desalination and purification, evaporation based process, supported by an effective combined utilization of said water boiling and evaporation by electrical heating through heater element 304, and further heated also by harnessing solar radiation energy using solar system 336 with solar collectors 338, or by circulation in a heat exchanger serpentine 334 waste heat from any accessible industrial or central heating/cooling processes, thus creating a combined-cycle desalination unit for efficient desalination of sea/brackish water in mobile application environments and conditions. The desalination apparatus 300 embodiment described in here is also characterized by the use of a special heat exchanger and condensation unit combined of a multiple of perforated pipes 316 equipped with an array of evaporated water hot steam spraying nozzles. The apparatus according to the present embodiment is comprising of: a first water container 307 containing cold saline water or waste water content wherein this first container 307 water content is being pre-heated though electric heating elements 304 and in parallel heating the water in the first container 307 by solar energy collected by an array of light to liquid solar water heating collectors 338, wherein the solar heated water is circulated through a closed loop water to water heat exchanger 334 immersed in said first container. In the following step the heated saline or waste water in first container 307 is boiling to create an upward flow of a streaming mix of steam and water vapors to be collected in a pipe 310 and further fed through this pipe into the second container 318. The water vapors streaming to the second container are flowing into an array of vertical perforated tubes in said second container with their upper end closed and said mixture is fed under pressure into the opened lower end of said perforated vertical tubes, pressurized into the inner volume of the vertical perforated tubes 316. The vapors and steam mixture is injected out of the perforated tubes 316 holes in a shape of multiple mini jet streams that streams into the air gaps between said two dimensional array of vertical perforated tubes and wherein a further cooled down air input of pumped atmosphere air made by air module 324,326 is enforced to flow by air injectors array 322 through the open air gaps existing between said two dimensional array of vertical perforated tubes 316, wherein said injected water vapors and steam mixtures is then being fast cooled down and further condensed on the walls of said second container 318 and on the external surfaces of said plurality of perforated tubes 316. All the walls of the second condensing container 318 are further cooled by water that is covering the entire outer surfaces of the second container 318 which is contained in a third external container 312 envelop that includes the cooling water 314 cooled through the apparatus integrated water cooling and circulation subunit 330 and 328. The condensed steam water droplets in the second condensing container 318 are then being further accumulated by gravity on the lower near base level of the second container 317 to be further accumulated through fresh drinkable water outlet 320 at an end of process, leading to an external consumable water tank.

Several utilizations of the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A method of conducting a water desalination process by providing an effective combined utilization of waste coolant sea water heat together with waste gases heat that are both generated from various sources at an electrical power station, thus creating a combined-cycle power generation plant and desalination unit for efficient desalination of sea/brackish water, said desalination process is also characterized by the use of waste heat of exhaust gases from combustion of fossil fuels at the power station while substantially and inherently in said process filtering out most contaminating materials within said exhaust gases thus reducing the air pollution created by said combustion exhaust gases to be then further released to the atmosphere, said process comprising of the following steps of:
a. collecting in a dedicated container and using preheated power station waste heat coolant sea water of typical 70-80 Deg. C. that were previously used to cool the turbines in a power station;
b. releasing super heated waste combustion process gas from a power generating turbine of typical temp of typical 180-200 Deg C. or above into said liquid container containing said waste heat sea water while in said process said hot waste gas is released under high positive pressure into said waste heat preheated sea water through a gas release device containing large area network arrays of mini/micro size nozzles thus releasing said gas into said heated sea water in the shape of bubbles of a typical mini and microspheres size, said bubbles permeate upwards through said preheated sea water layer while through this process said very hot released gas bubbles absorb and contain in them a hi quantity of water vapors absorbing it from the very locally further heated and boiled sea water, as said bubbles move up through said preheated waste seawater layer,
c. said super heated gas bubbles then containing a high content of water vapors are emerging out of said pre-heated sea water layer to be then further cooled while said gas bubbles water vapors content is released and condenses into pure water on the surface of a cooling heat exchanger resident within a second air filled container immersed in the open sea water for initial cooling while said heat exchanger is being further cooled down by cold air;
d. said condensed water droplets accumulated on the surfaces of said heat exchanger are further collected by gravity from the surfaces of said heat exchanger and pumped to a reservoir containing purified desalinated water for further use; and
e. wherein said polluting waste combustion process gases are further released from said dedicated container through a dedicated filter to the open atmosphere thus after most of their contaminating ingredients are already dissolved during said gas bubbling process into said heated sea water in said container and further precipitating down into said container lower section volume from where they are extracted as a brine slurry being further pumped filtered out and separated in a separate process.

2. The method of claim 1, wherein said heat exchanger within said air filled second container is constructed from a very large array of parallel vertical metal plates or parallel tubes and wherein:
a. in the air spaces existing between said metal plates or within said tubes said team and water vapors stream coming from said first sea water steam generation container are enforced to pass and to cool down on said metal plates and tubes up to the stage of being further condensed and accumulated on said heat exchanger surfaces into purified clean water droplets;
b. said metal plates or pipes array further cooled down by forced air blown vertical to steam flow direction wherein said cool air is cooled down to low temperature by first pumping into an air cooling unit extracting open atmospheric air and then further pumping said air to be further cooled down through an water to air heat exchanger that is immersed in colder deep sea water where average sea water temperature if far below outdoor air temperature by typically 10-20 degrees C.; and
c. wherein said water droplets further drip down by gravity on said plates or tubes inner surfaces to be further accumulated in a lower level end product container and pumped out of said end product container as desalinated fresh water to be further consumed.

3. The method of claim 1, wherein said combustion gas is not directly mixed with said sea water to create said desalination process, but the two processes are separated, and wherein;
a. said waste combustion process gas is first flowing through a gas to water heat exchanger immersed in said first evaporation container to further heat up said waste heat hot sea water to a boiling level of, thus creating steam based process evaporation of said waste sea water, wherein said steam level water vapors are to be further condensed in said second container into desalinated water and wherein said waste combustion process gas is being in parallel also cooled down to above water boiling temperature through said sea water heating process in said first container; and
b. said cooled combustion gas is then further flowing into a third container also containing said waste heat hot sea water, wherein said hot waste gas is slowly released into said waste heat preheated sea water through a large area network arrays of mini/micro size nozzles, wherein through said cooled down waste combustion process gas bubbling process through said waste heat sea water most of said combustion process waste gas contaminating ingredients are dissolved into said heated sea water in said third container and then further precipitating down into said third container lower level above its bottom, from where said contaminating ingredients are extracted as a brine slurry and being further pumped out of said third container while said combustion gas further cooled down when previously released as gas in water bubbles in said third container is then further released to the atmosphere from said third container top, while said released gas is then containing much less contamination pollutant ingredients in it.

4. The method of claim 3, wherein said further cooled down combustion gas released to the top level of said third container is further collected and enforced into the inlet of said gas to water heat exchanger immersed in said first evaporation container to further boost the faster heating up of said waste heat hot sea water to a boiling level and the creation of fast evaporation and steam streaming out of said first container.

5. The method of claim 1, wherein
a. said cooling heat exchanger within said second air filled container is constructed from a two dimensional matrix array of vertical tubes which are closed in their upper ends, said tubes are perforated with sub-millimeter dense array of nozzles or holes around each of said vertical tubes perimeter and along their length;
b. wherein said steam coming from said first container is streaming and enforced into the inner volumes of said array of perforated tubes from their lower open end into the inner volume of said vertical perforated tubes and then released out through said perforated array of nozzles in said vertical tubes to said second container air volume: and
c. said steam coming from said first container is then being cooled down by forced cooled down fresh air pumped into said second container air volume to be further condensed into water droplets on the inner surfaces of said second container.

6. The method of claim 1, wherein said desalinated water created by accumulated condensed water droplets collected by gravity from the surfaces of said heat exchanger and further accumulated in said water reservoir containing purified desalinated water, is further filtered purified and processed to get very high quality drinkable water, following the steps of:
a. pumping said desalinated water through a membrane filter to clean all residual particles and contaminating non-solvent ingredients;
b. passing said filtered desalinated water that may still contain residual combustion gas contained pollutant chemicals and heavy metals, through a series of chemical contained in pollutant chemicals and heavy metals reactive and absorbing filters that will react and absorb all still existing residual contaminating chemicals and material still dissolved in said desalinated water, said absorbing and actively reactive materials in said reactive filters are selected from the materials group including at least Sodium Metal Bi-sulfate, Sodium Hydroxide, Citric acid and Sodium Hypochlorite;
c. said chemically filtered desalinated water then going through a Carbon filter to get rid of all live organisms and organic molecules and residues.
d. Said carbon filtered desalinated water is then further pumped and passing going through a one direction valve and a pulsating water high pressurizing pump to be fed into an pressure enforced reverse osmosis process subsystem;
e. said reverse osmosis (RO) subsystem contains at least two reverse osmosis cylinder filter units, wherein one such filter being connected to the other in series and wherein the output of one of said RO filters is fed to the water inlet of the other RO filter, wherein in each such reverse osmosis cylinder filter serial units the desalinated water are then pressurized inside the inner membrane tube and said water is permeating through the selective inner tube membrane that is passing through only water molecules and filtering out all other molecules;
f. the water inlet to said RO sub-system is further pressurized to boost the reverse osmosis process efficiency by feeding to its water inlet released gas pressure from said first container after being filtered and pumped to said RO sub-system through a one direction valve; and
g. said post final RO filtration stage desalinated water output is then pumped and fed into a pressurized water tank from where fresh drinkable water are supplied.

7. The method of claim 1, wherein said first sea hot water container is containing a special gas permeation unit, wherein:
a. said waste combustion process gas input fed into said first container is streaming and self pressure enforced into the inner volumes of a two dimensional array of perforated vertical tubes with a closed upper cap;
b. wherein said gas flowing into said tubes from their lower open end pressurized into the inner volume of said vertical perforated tubes and then released out through said perforated array of nozzles in said vertical tubes to said first container hot sea water to create a high rate up raising condensed volume of flow of miniature gas bubbles enriched with water vapors and water steam; and
c. said water vapors and water steam then further released to the air volume in the upper level of said first container and then said steam and vapors are led through a steam conducting pipe to said second container wherein said steam and water vapors are condensed to provide a volume of desalinated water.

8. The method of claim 1, wherein in said second container said cooling heat exchanger within said second air filled container is constructed from a two dimensional matrix array of vertical tubes which are closed in their lower ends, said tubes are perforated with sub-millimeter dense array of nozzles or holes around each of said vertical tubes perimeter and along their length; further comprising the steps of:
a. said water vapors and steam streaming from said first container to said second tube and then flowing into said vertical tubes from their upper opened end pressurized into the inner volume of said vertical perforated tubes;
b. said water vapors and steam mixture then released out through said perforated array of nozzles in said vertical tubes to said second container cooled down in its entire air volume by cooled streaming air jets to cool fast said volume of water steam injected through said pipes nozzles to create a high rate of down falling flow of a condensed volume of miniature in-air condensed water droplets;
c. said micro size water droplets in said condensed droplets volume are dropping down to said second container bottom sloped bottom while additional drops are accumulated from water vapors condensed on the cold walls of sad second container; and
d. all accumulated condensed steam desalinated water drops are then streaming down the sloped bottom of said second container to be accumulated in a lower level water storage tank and then further pumped up for consumption.

9. The method of claim 1, wherein in said first and said second containers functions are merged into one unified container and where said first container is encased within said second container, the desalination process comprising the unified steps of:
a. waste combustion process gas input being fed into said first container and permeates through said waste sea water as a hot gas and steam combined mixture encased within bubbles all flowing up towards the higher air filled part of said first container, wherein said gas containing bubbles are created through said gas release device containing large area network arrays of mini/micro size nozzles immersed in said sea water which is contained in said first container;
b. Said mix waste process gas and steam bubbles are reaching the sea water surface level and convert to a steam and vapors mix condensed volume emerging through and out of sad first container upper cover roof tiles slits structured enclosed cap, wherein said mixture is emerging out between said first container roof tiles to said second air filled volume container, containing said first container;
c. a cooling heat exchanger within said second air filled container is constructed from a two dimensional matrix array of vertical tubes which are closed in their lower ends, said tubes are perforated with sub-millimeter dense array of nozzles or holes around each of said vertical tubes perimeter and along their length;
d. said water vapors and steam mix up streaming from said first container to said tube and then in said second container flowing in the open air gaps between said vertical perforated tubes and then being cooled down and further condensed on said plurality of perforated tubes by a plurality of streams of forces cooled air injected from the large plurality of cold air jets emerging for the plurality of cold air nozzles, said cold air being fed into said vertical tubes from their upper opened end pressurized into the inner volume of said vertical perforated tubes;
e. said water vapors and steam mixture, cooled down and condensed on said multiple perforated cold tubes outer surfaces create a high rate of down falling flow of a volume of condensed miniature water droplets falling on said first container upper roof tiles structure cover to be then further dripping along the slopes of said roof tile structured cover, and
f. said water droplets are then being further accumulated by gravity on the lower near base level of said second containers to be further accumulated at a lower ground level, end of process desalinated water tank;

10. The method of claim 1, wherein:
a. said first water container contains cold saline water or waste water content is not connected to a power station supply input, therefore said first container water content is being pre-heated though electric heating elements and in parallel heating said water by solar energy collected by an array of light to liquid solar water heating collectors, wherein said solar heated water is circulated through a closed loop water to water heat exchanger immersed in said first container;
b. said heated saline or waste water in first container is boiling to create an upward flow of a streaming mix of steam and water vapors to be collected in a pipe and further fed through said pipe into said second container;
c. said water vapors and steam mixture streaming from said first container to said second tube then flowing into an array of vertical tubes with their upper end closed and said mixture is fed under pressure into the opened lower end of said perforated vertical tubes, pressurized into the inner volume of said vertical perforated tubes;
d. said vapors and steam mixture injected in multiple mini jet streams into the air gaps between the two dimensional array of vertical perforated tubes and wherein a cooled down pumped atmosphere air is enforced to flow through the open air gaps existing between said vertical perforated tubes, wherein said water vapors and steam mixtures is then being cooled down and further condensed on said plurality of perforated tubes by a plurality cooled air nozzles; and
e. said water droplets are then being further accumulated by gravity on the lower near base level of said second containers to be further accumulated at an end of process consumable water tank.

11. A system for conducting a water desalination process by providing an effective combined utilization of waste coolant sea water heat together with waste gases heat that are both generated from various sources at an electrical power station, thus creating a combined-cycle power generation plant and desalination unit for efficient desalination of sea/brackish water, said desalination process is also characterized by the use of waste heat of exhaust gases from combustion of fossil fuels at the power station while substantially and inherently in said process filtering out most contaminating materials within said exhaust gases thus reducing the air pollution created by said combustion exhaust gases to be then further released to the atmosphere, said system comprising of:
a. a dedicated first container for collecting preheated power station waste heat coolant sea water of typical 70-80 Deg. C. that were previously used to cool the turbines in a power station;
b. a gas conduction inlet in said first container dedicated for releasing into said first container super heated waste combustion process gas from a power generating turbine of typical temperature of typical 180-200 Deg. C.
c. a gas release device containing a large area network of arrays of mini/micro size nozzles for releasing said combustion process gas into said heated sea water in the shape of bubbles of a typical mini and microspheres size, wherein said gas release device is immersed at the lower part of said first waste sea water container, wherein said gas bubbles permeate upwards through said preheated sea water layer while through this process said very hot released gas bubbles absorb and contain in them a hi quantity of water vapors;
d. a water steam and vapors collection sub-unit in said first container collecting the high content of water vapors emerging out of said pre-heated sea water layer to be then conducted through a duct and further cooled in a second dedicated container,
e. a second dedicated container wherein water vapors content condenses into pure water droplets on the surface of a cooling heat exchanger resident within said second air filled container immersed in the open sea water for initial cooling while said heat exchanger within said second container is being further cooled down by cold air and wherein said condensed water droplets r cumulated by gravity in the lower section of said second container and accumulated in a lower level water reservoir, containing purified desalinated water,
f. a dedicated filter through which said polluting waste combustion process gases are further released from said first container to the open atmosphere thus after most of their, and
g. a drainage sub-unit for collecting contaminating ingredients that are dissolved during said gas bubbling process into said heated sea water in said first container, wherein said contaminating ingredients precipitating down into said container lower section volume from where they are extracted as a brine slurry being further pumped filtered out and separated in a separate process.

12. The system of claim 11, wherein said heat exchanger within said air filled second container is constructed from a very large array of parallel vertical metal plates, or parallel vertical tubes and any combination thereof and wherein:
a. in the air spaces existing between said metal plates or within said tubes said steam and water vapors stream coming from said first sea water steam container are enforced to pass and to cool down said steam and water vapors on metal plates and tubes up to the stage of being further condensed and accumulated on said heat exchanger surfaces into purified clean water droplets;
b. an air cooling unit extracting open atmospheric air and then further pumping said air to be further cooled down through a water to air heat exchanger that is immersed in colder deep sea water where average sea water temperature if far below outdoor air temperature by typically 10-20 degrees C.;
c. said metal plates or pipes array further cooled down by forced air blown vertical to steam flow direction wherein said cool air by said cooling unit; and
d. said water droplets further drip down by gravity on said cooled plates or tubes inner surfaces to be further accumulated in a lower level product third container and pumped out of said end product container as desalinated fresh water to be further consumed.

13. The system of claim 11, wherein said combustion gas is not directly mixed with said sea water to create said desalination process, but the two processes are separated, further comprising:
a. a gas to water heat exchanger immersed in said first sea water container to further heat up said waste heat hot sea water to a boiling level of by circulating said hot combustion gas through said heat exchanger, thus creating steam based process evaporation of said waste sea water wherein said waste combustion process gas is first flowing through said gas to water heat exchanger;
b. a third container also containing said waste heat hot sea water, wherein said post heat exchanger stage combustion gas is then further flowing into said third container also containing said waste heat hot sea water, wherein said hot waste gas is slowly released into said waste heat preheated sea water through said device with large area network arrays of mini/micro size nozzles and wherein through said cooled down waste combustion process gas bubbling process through said waste heat sea water most of said combustion process waste gas contaminating ingredients are dissolved into said heated sea water in said third container and then further precipitating down; and
c. a forth container at a lower level above its bottom of said third container from where said contaminating ingredients are extracted as a brine slurry and being further pumped out of said forth container while said combustion gas further cooled down when previously released as gas in water bubbles in said third container is then further released to the atmosphere from said third container top, while said released gas is then containing much less contamination pollutant ingredients in it.

14. The system claim 13, wherein said further cooled down combustion gas released to the top level of said third container is further collected and enforced into the inlet of said gas to water heat exchanger immersed in said first container to further boost the faster heating up of said waste heat hot sea water to a boiling level and the creation of faster evaporation and steam streaming out of said first container.

15. The system of claim 11, wherein:
a. said cooling heat exchanger within said second air filled container is constructed from a two dimensional matrix array of vertical tubes which are closed in their upper ends, said tubes are perforated with sub-millimeter dense array of nozzles or holes around each of said vertical tubes perimeter and along their length;
b. wherein said steam coming from said first container is streaming to said cooling heat exchanger in said second container and then enforced to enter into the inner volumes of said array of perforated tubes from their lower open end pressurized into the inner volume of said vertical perforated tubes and then released out through said perforated array of nozzles in said vertical tubes to said second container air volume;
c. said steam spray coming from said nozzles in second container is then being cooled down to condensation by forced cooled down fresh air streams pumped into said second container air volume for the steam spay further condensed into water droplets on the inner surfaces of said second container, and
d. said water droplets are sliding by gravity down the walls of said second container to accumulate in a third desalinated water container situated at the bottom of said container

16. The system of claim 11, wherein said desalinated water created by accumulated condensed water droplets collected by gravity from the surfaces of said heat exchanger and further accumulated in said water reservoir containing purified desalinated water, is then further filtered, purified and processed to get very high quality drinkable water, comprising the water further processing sub-units of:
a. pumping said desalinated water through a membrane filter unit to clean all residual particles and contaminating non-solvent ingredients;
b. a series of chemical filtrating and absorbing active filters designed to absorb pollutant gas residual inherent chemicals and heavy metals reactive that will react and absorb all still existing residual contaminating chemicals and material that might be dissolved in said desalinated water, said absorbing and actively reactive materials in said reactive filters are selected from the materials group including at least Sodium Metal Bi-sulfate, Sodium Hydroxide, Citric acid and Sodium Hypochlorite;
c. a Carbon filter to get rid of all live organisms and organic molecules and residues in said desalinated water.
d. a one direction valve and a pulsating water high pressurizing pump to mump said desalinated water to be then further pumped through into an pressure enforced reverse osmosis process subsystem;
e. said reverse osmosis (RO) subsystem contains at least two reverse osmosis cylinder filter units, wherein one such filter being connected to the other in series and wherein the output of one of said RO filters is fed to the water inlet of the other RO filter, wherein in each such reverse osmosis cylinder filter serial units said desalinated water are then pressurized inside the inner membrane tube and then said water is permeating through the selective inner tube membrane that is passing through only water molecules and filtering out all other molecules; and
f. said post final RO filtration stage desalinated water output is then pumped and fed into a pressurized water tank from where fresh drinkable water are supplied.

17. The system of claim 11, wherein said first hot water container, further comprising a special gas permeation unit:
a. said special gas permeation unit is made of a two dimensional array of perforated vertical tubes with a closed upper cap; wherein waste combustion process gas input fed into said first container is streaming and by its self pressure enforced into the inner volumes of a two dimensional array of perforated vertical tubes with a closed upper cap;
b. wherein said gas flowing into said tubes from their lower open end pressurized into the inner volume of said vertical perforated tubes and then released out through said perforated array of nozzles in said vertical tubes to said first container hot sea water to create a high rate of up raising condensed volume and of flow of miniature gas bubbles enriched with water vapors and water steam; and
c. said water vapors and water steam then further released to the air volume in the upper level of said first container and then said steam and vapors are led through a steam-conducting pipe to said second container wherein said steam and water vapors are condensed to provide a volume of desalinated water.

18. The system of claim 11, wherein in said second container said cooling heat exchanger within said second air filled container is constructed from a two dimensional matrix array of vertical tubes which are closed in their lower ends, said tubes are perforated with sub-millimeter dense array of nozzles or holes around each of said vertical tubes perimeter and along their length; further comprising the steps of:
a. said water vapors and steam streaming from said first container to said second tube and then flowing into said vertical tubes from their upper opened end pressurized into the inner volume of said vertical perforated tubes;
b. said water vapors and steam mixture then released out through said perforated array of nozzles in said vertical tubes to said second container cooled down in its entire air volume by cooled streaming air jets to cool fast said volume of water steam injected through said pipes nozzles to create a high rate of down falling flow of a condensed volume of miniature in-air condensed water droplets;
c. said micro size water droplets in said condensed droplets volume are dropping down to said second container sloped bottom while additional drops are accumulated from water vapors condensed on the cold walls of sad second container, and
d. all accumulated condensed steam desalinated water drops are then streaming down the sloped bottom of said second container to be accumulated in a lower level water storage tank and then further pumped up for consumption.

19. The system of claim 11, wherein in said first and said second containers functions are merged into one unified container and where said first container is encased within said second container, said desalination system comprising:
a. a gas release device containing large area network arrays of mini/micro size nozzles immersed in said sea water which is contained in said first container, wherein waste combustion process gas input being fed into said first container and permeates through said waste sea water as a hot gas and steam combined mixture encased within bubbles all flowing up towards the higher air filled part of said first container,
b. said waste combustion process gas input being fed into said first container and permeates through said waste sea water as a hot gas and steam combined mixture encased within bubbles all flowing up towards the higher air filled part of said first container, wherein said gas containing bubbles are created through said gas release device containing large area network arrays of mini/micro size nozzles immersed in said sea water which is contained in said first container;
c. Said mix waste process gas and steam bubbles are reaching the sea water surface level and convert to a steam and vapors mix condensed volume emerging through and out of sad first container upper cover roof tiles slits structured enclosed cap, wherein said mixture is emerging out between said first container roof tiles to said second air filled volume container, containing said first container;
d. a cooling heat exchanger within said second air filled container is constructed from a two dimensional matrix array of vertical tubes which are closed in their lower ends, said tubes are perforated with sub-millimeter dense array of nozzles or holes around each of said vertical tubes perimeter and along their length;
e. said water vapors and steam mix up streaming from said first container to said tube and then in said second container flowing in the open air gaps between said vertical perforated tubes and then being cooled down and further condensed on said plurality of perforated tubes by a plurality of streams of forces cooled air injected from the large plurality of cold air jets emerging for the plurality of cold air nozzles, said cold air being fed into said vertical tubes from their upper opened end pressurized into the inner volume of said vertical perforated tubes;
f. said water vapors and steam mixture, cooled down and condensed on said multiple perforated cold tubes outer surfaces create a high rate of down falling flow of a volume of condensed miniature water droplets falling on said first container upper roof tiles structure cover to be then further dripping along the slopes of said roof tile structured cover, and
g. said water droplets are then being further accumulated by gravity on the lower near base level of said second containers to be further accumulated at a lower ground level, end of process desalinated water tank.

20. The system of claim 11, wherein:
a. said first water container contains cold saline water or waste water content is not connected to a power station supply input, therefore said first container water content is being pre-heated though electric heating elements and in parallel heating said water by solar energy collected by an array of light to liquid solar water heating collectors, wherein said solar heated water is circulated through a closed loop water to water heat exchanger immersed in said first container;
b. said heated saline or waste water in first container is boiling to create an upward flow of a streaming mix of steam and water vapors to be collected in a pipe and further fed through said pipe into said second container;
c. said water vapors and steam mixture streaming from said first container to said second tube then flowing into an array of perforated vertical tubes with their upper end closed and said steam and water vapors mixture is fed under pressure into the opened lower end of said perforated vertical tubes, pressurized into the inner volume of said vertical perforated tubes;
d. said vapors and steam mixture injected out of said perforated tubes in multiple mini jet streams into the air gaps between said two dimensional array of vertical perforated tubes, wherein a cooled down pumped atmosphere air stream is enforced to flow through the open air gaps existing between said vertical perforated tubes, wherein said water vapors and steam mixtures is then being cooled down and further condensed to water droplets on said plurality of perforated tubes; and
e. said water droplets are then being further accumulated by gravity on the lower near base level of said second containers to be further accumulated within an end of process consumable water tank.

21. An apparatus providing a portable cost effective salty water desalination and purification, evaporation based process, supported by an effective combined utilization of said water boiling and evaporation by electrical heating, further heated also by harnessing solar radiation energy or by circulation in a heat exchanger waste heat from any accessible industrial or central heating/cooling processes, thus creating a combined-cycle desalination unit for efficient desalination of sea/brackish water, said desalination process is also characterized by the use of a special heat exchanger and condensation unit combined of a multiple of perforated pipes equipped with an array of evaporated water hot steam spraying nozzles, said apparatus comprising of:
a. a first water container containing cold saline water or waste water content wherein said first container water content is being pre-heated though electric heating elements and in parallel heating said water by solar energy collected by an array of light to liquid solar water heating collectors, wherein said solar heated water is circulated through a closed loop water to water heat exchanger immersed in said first container;
b. said heated saline or waste water in first container is boiling to create an upward flow of a streaming mix of steam and water vapors to be collected in a pipe and further fed through said pipe into said second container;
c. said water vapors streaming to said second container flowing into an array of vertical perforated tubes in said second container with their upper end closed and said mixture is fed under pressure into the opened lower end of said perforated vertical tubes, pressurized into the inner volume of said vertical perforated tubes;
d. said vapors and steam mixture is injected out of said perforated tubes holes in a shape of multiple mini jet steam streams into the air gaps between said two dimensional array of vertical perforated tubes and wherein a further cooled down pumped atmosphere air is enforced to flow through the open air gaps existing between said two dimensional array of vertical perforated tubes, wherein said injected water vapors and steam mixtures is then being fast cooled down and further condensed on the walls of said second container and on the external surfaces of said plurality of perforated tubes; and
e. said condensed steam water droplets are then being further accumulated by gravity on the lower near base level of said second containers to be further accumulated at an end of process to a consumable water tank.
